(19) United States
(12) Patent Application Publication
(10) Pub. No.: US 2004/0150276 A1
(43) Pub. Date: Aug. 5, 2004

(54) Method of connecting motor lead wires, connection structure, and motor

(75) Inventors: Takeshi Yokoyama, Anjo-shi (JP); Tooru Kuroyanagi, Anjo-shi (JP)

Correspondence Address: OLIFF & BERRIDGE, PLC, P.O. BOX 19928, ALEXANDRIA, VA, 22320, US

(73) Assignee: AISIN AW CO., LTD., ANJO-SHI (JP)

(21) Appl. No.: 10/740,855

(22) Filed: Dec. 22, 2003

(30) Foreign Application Priority Data
Dec. 27, 2002 (JP) 2002-378964

(51) Int. Cl. H02K 11/00

(52) U.S. Cl. 310/71

(57) ABSTRACT

A method of connecting a plurality of motor lead wires formed with an insulating coating while ensuring electric conduction among them. In connecting the motor lead wires through a connection terminal, a fusing process is executed after a passing-through process is executed. The passing-through process is one in which the motor lead wires arranged in parallel are passed through slots in the connection terminal. The fusing process is one in which a pair of side plate portions facing each other with the motor lead wires interposed therebetween is sandwiched between opposing electrodes to be pressurized, and a predetermined current is conducted between the opposed electrodes from one of the side plate portions to the other of the side plate portions to generate heat to electrically connect the connection terminal and the motor lead wires to each other.

This application claims priority from JP 2002-378964 filed Dec. 27, 2002, the disclosure of which is incorporated herein by reference thereto.

### BACKGROUND OF THE INVENTION

1. Field of Invention

The invention relates to a connection structure of motor lead wires in a motor.

2. Description of Related Art

With conventional stators in motors, a plurality of motor lead wires are in some cases bundled and connected. For example, motor lead wires 9 serving as neutral wires in coils on a stator core 93 of stator 92 of a three-phase motor are connected together as shown in FIGS. 16 and 17.

In a connection structure shown in the figures, coil terminals 91 of neutral wires 9 are bundled and connected together to form neutral terminals 90. Here, the neutral terminals 90 are joined by means of wrapping, caulking, which provide mechanical joining, soldering making use of brazing filler metal, welding, and so on.

The neutral terminals 90 thus formed are arranged adjacent to coil aggregates 95 in an axial direction (horizontal direction in FIG. 17) (see, for example, JP-A-2002-199634 (page 2, FIG. 2).

### SUMMARY OF THE INVENTION

However, the conventional connection structure of motor lead wires has the following problem, that is, because the neutral terminals 90 are arranged adjacent to the coil aggregates 95, a length of the coil aggregates 95, in an axial direction, is extended a magnitude corresponding to a diameter D of the neutral terminals 90.

In particular, when the number of parallel stator coils in, for example, motors for electric motorcars is large, the number of motor lead wires 9 being bundled is increased and the diameter D of the neutral terminals 90, to bundle the motor lead wires 9, is correspondingly increased.

In this case, the stator 92 being lengthy in the axial direction enlarges a size of the whole motor in the axial direction to cause a fear that its loading workability for the motorcar is worsened.

In view of such problems in the conventional art, the invention provides a method of connecting a plurality of motor lead wires with a high reliability in the connection, a connection structure, and a motor making use of the same.

The invention provides a method of connecting a plurality of motor lead wires formed with an insulating coating while ensuring electric conduction among them, the method comprising using a connection terminal, which has holes formed so as to permit the motor lead wires, parallelly arranged, to extend therethrough, a pair of side plate portions formed on both sides of the holes, and bridge portions connecting the pair of side plate portions to each other, to execute a passing-through process, in which the motor lead wires in a parallelly arranged state are passed through the holes of the connection terminal, and then executing a fusing process, in which the side plate portions facing each other with the motor lead wires interposed therebetween are interposed by a pair of electrodes to be pressurized, and a predetermined current is conducted from one of the side plate portions to the other of the side plate portions to generate heat to electrically connect the connection terminal and the motor lead wires to each other.

In the passing-through process in the method of connecting motor lead wires, according to the first invention, the motor lead wires parallelly arranged in a gap between the side plate portions are passed through the holes in a parallelly arranged state.

Therefore, the respective motor lead wires can be surely set on the connection terminal in the passing-through process by passing the motor lead wires through the holes to position the same with tip ends thereof projecting from the holes.

Also, because the tip ends of the motor lead wires are caused to project from the holes, in the manner described above, after the respective motor lead wires are set, it is possible to readily check whether the respective motor lead wires have been correctly set. This method of checking can be readily realized by, for example, a method of inspection with the use of image processing, magnetic sensors, or the like, in addition to visual checking, in which the respective motor lead wires projecting from the holes are visually confirmed.

Further, in spite of a dispersion in lengths of the respective motor lead wires, such dispersion is easily regulated by passing the lines through the holes. That is, dispersion in lengths of the respective motor lead wires can be regulated by adjusting the lengths of those portions which project through the holes.

Further, with the method of connecting motor lead wires, the fusing process, in which the predetermined current is conducted from one of the side plate portions to the other of the side plate portions, is executed after the passing-through process is executed. In the fusing process, current can be conducted in a concentrated manner to the bridge portions, which connect the pair of side plate portions. And such bridge portions are adjacent to the holes.

Here, there is generally a fear in the fusing process that a large quantity of heat is externally radiated at both ends of the parallelly arranged motor lead wires and thus both ends are not adequately heated.

With the connection terminal, however, because heating is applied from a side of the bridge portions on both sides of the motor lead wires parallelly arranged to pass through the holes, both ends can be adequately heated. Therefore, the electric connection of the respective motor lead wires can be surely effected in the gap between a pair of the side plate portions by the fusing process with the use of the connection terminal.

Also, a product material, such as carbide or the like, which is possibly generated by heat in the fusing process, can be discharged outside from the holes. Therefore, there is little fear that contact between the side plate portions of the connection terminal and outer peripheral surfaces of the motor lead wires is obstructed by the carbide or the like.

Further, the invention provides a connection structure of the motor lead wires, in which a plurality of motor lead wires are connected together while electric conduction among them is ensured, the connection structure comprises a connection terminal having slots formed so as to permit the motor lead wires as parallelly arranged to extend therethrough, a pair of side plate portions interposing the motor lead wires passing through the slots to face each other, and bridge portions connecting the pair of side plate portions to each other. The motor lead wires in a parallelly arranged state are passed through the slots, and interposed between the pair of side plate portions to be electrically connected to the connection terminal.

With the connection structure according to the second invention, the motor lead wires as parallelly arranged are extended through the slots of the connection terminal. Therefore, the connection structure makes it possible to arrange a plurality of motor lead wires that are thin in a heightwise direction.

Also, with the connection structure, the parallelly arranged motor lead wires project outside from the slots. Therefore, it is possible to readily carry out a check of contact between the motor lead wires and the connection terminal. That is, whether a good or bad state of contact between the connection terminal and the respective motor lead wires is good or bad can be readily judged on the basis of whether the respective motor lead wires project from the slots. For example, such a judgment can be made by a method of inspection using image processing, magnetic sensors, or the like, in addition to visual checking, in which the respective motor lead wires projecting from the slots are visually confirmed.

Also, the invention provides a motor comprising a ring-shaped stator core, on which coils constituting respective motor phases are arranged, and a neutral terminal ensuring mutual electric conduction of a plurality of motor lead wires, which are drawn from the respective motor phases to serve as neutral wires, and to connect them, wherein the neutral terminal is structured to connect the motor lead wires according to any of the aspects mentioned above. The motor comprises the neutral terminal, at which the neutral wires, parallelly arranged in a gap between the opposed side plate portions, are electrically connected to the connection terminal. Therefore, a thickness of the neutral terminal in a direction, in which the side plate portions are opposed to each other, is not affected by the number of neutral wires. Also, the neutral wires are connected to the connection terminal in a state in which they project from the slots. Therefore, an electric connection between the neutral wires and the connection terminal is assured, and post checking of the connection is easy.

In the invention, it is preferable that the holes are slots slit in a longitudinal direction and the pair of side plate portions are formed on both sides of the slots in the longitudinal direction. In such a case, the motor lead wires can be efficiently arranged in parallel relative to the slots.

Also, the predetermined current is preferably changed in magnitude according to cross sectional areas of the bridge portions in the fusing process. As a result, fear that the bridge portions might melt to cause separation of the respective side plate portions is reduced by appropriately setting the predetermined current in the fusing process.

Further, the insulating coating formed on outer peripheries of the motor lead wires is preferably carbonized in the fusing process. In such a case, there is no need to peel the insulating coating off the motor lead wires, so an improvement in working efficiency can be achieved.

The carbide generated by carbonization of the insulating coating can be discharged to the outside from the holes. Therefore, there is little fear that the carbide remaining in the insulation terminal obstructs contact between the motor lead wires and the insulation terminal.

Also, the passing-through process is preferably executed for the connection terminal, in which the pair of side plate portions are formed to face each other. In this case, the motor lead wires can be inserted into a gap between the opposed side plate portions to be passed through the holes.

It is also preferable that after the passing-through process is executed and before the fusing process is executed, the connection terminal is bent in a manner to have the pair of side plate portions facing each other. In this case, it is possible to carry out the passing-through process, in which the motor lead wires are passed through the holes, with good workability.

In the passing-through process, the motor lead wires may be extended through the connection terminal, of which the pair of side plate portions assume an obtuse angle, or the motor lead wires may be extended through the connection terminal, of which the pair of side plate portions assume an acute angle including a right angle.

In addition, it is preferable that after the fusing process, tip ends of the motor lead wires projecting outside from the slots are cut. In this case, lengths of those portions of the motor lead wires, which project outside from the connection terminal, can be reduced by cutting ends of the motor lead wires. By regulating lengths of the motor lead wires projecting outside from the holes, it is possible to eliminate the dispersion in lengths of the respective motor lead wires leading to the connection terminal from the motor phases. And, by cutting tip ends of the motor lead wires projecting outside from the holes, it is possible to completely eliminate the dispersion in lengths of the motor lead wires drawn from the motor phases.

Also, it is preferable that after the fusing process, an insulating process is executed, in which the connection terminal and the respective motor lead wires disposed in the vicinity thereof are covered by an insulating paper that is electrically insulative. In this case, it is possible to surely maintain insulation for the connection terminal and the motor lead wires disposed in the vicinity thereof.

Further, in the invention, it is preferable that the edges of the connection terminal adjacent to the slots are formed with projections to project toward a gap between the pair of side plate portions, and the projections engage with the motor lead wires. In this case, the motor lead wires interposed in the connection terminal thus bent can be maintained high in mechanical strength by engagement of the projections.

Also, it is preferable that the connection terminal comprises a plurality of the slots and the plurality of motor lead wires are passed through the respective slots in a parallelly arranged state. In this case, the connection terminal can be increased in rigidity by connecting the pair of side plate portions together by means of the plurality of bridge portions and the motor lead wires can be firmly interposed in a gap between the pair of side plate portions.

In the case of, for example, realizing the connection structure by the fusing process, it is possible to highly uniformly connect the motor lead wires to the connection terminal. That is, because with this connection terminal, spacings of the bridge portions, to which current for fusing processing is concentratedly conducted, are small, and so it is possible to restrain temperature distribution, which is liable to impinge on the motor lead wires, which are arranged adjacent to the respective slots, in a direction of arrangement.

Also, it is preferable that the connection terminal and the respective motor lead wires disposed in the vicinity thereof are covered by an insulating paper that is electrically insulative. In this case, it is possible to assure insulation for the connection terminal and the motor lead wires disposed in the vicinity thereof.

Lastly, in the invention, it is preferable that a connection terminal on the neutral terminal is arranged on an outer peripheral surface of the stator core and the connection terminal assumes a substantially arcuate shape along the outer peripheral surface of the stator core. In this case, by arranging the connection terminal on the outer peripheral side of the stator core, the motor can be further reduced in length in the axial direction.

Also, it is preferable that the connection terminal on the neutral terminal comprises separate slots every motor phase and the neutral wires for the respective motor phases are passed through the respective slots. In this case, the neutral wires for the respective motor phases are arranged efficiently on the connection terminal to thereby enable making the neutral terminal compact in configuration.

Lastly, it is preferable that the neutral terminal defines a neutral point in a three-phase motor. In this case, the three-phase motor making use of the neutral terminal can be made compact.

### BRIEF DESCRIPTION OF THE DRAWINGS

The invention will be described with reference to the drawings, in which:

FIG. 1 is a front view showing a stator in an embodiment of the invention;

FIG. 2 is a side, cross sectional view showing a cross sectional structure of the stator;

FIG. 3 is a front view showing a connection terminal before bending;

FIG. 4 is a front view showing the connection terminal;

FIG. 5 is a cross sectional view taken along the line 5-5 in FIG. 4;

FIG. 6 is a view illustrating a passing-through process;

FIG. 7 is a view showing the connection terminal having therethrough neutral wires;

FIG. 8 is a view showing the connection terminal having therethrough the neutral wires;

FIG. 9 is a view illustrating a fusing process;

FIG. 10 is a view illustrating the fusing process;

FIG. 11 is a graph indicating temperature distribution on side plate portions of the connection terminal in the fusing process;

FIG. 12 is a view showing a bus bar wrapped in insulating paper;

FIG. 13 is a view illustrating a mount work of the bus bar;

FIG. 14 is a front view showing a test piece of a modification of the embodiment;

FIG. 15 is a graph indicating the relationship between a cross sectional area of bridge portions and threshold current values in the modification;

FIG. 16 is a front view showing a stator in a related art; and

FIG. 17 is a side, cross sectional view showing a cross sectional structure of the stator in the related art.

### DETAILED DESCRIPTION OF THE PREFERRED EMBODIMENT

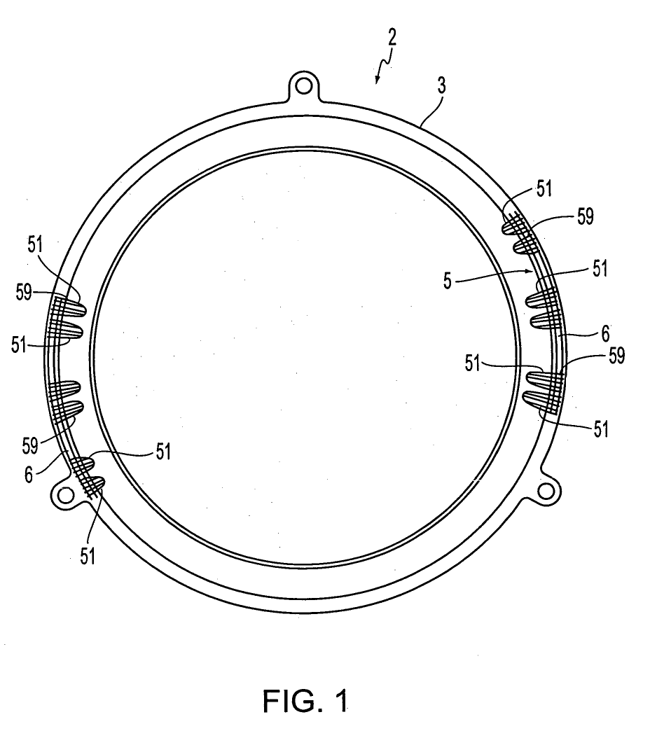

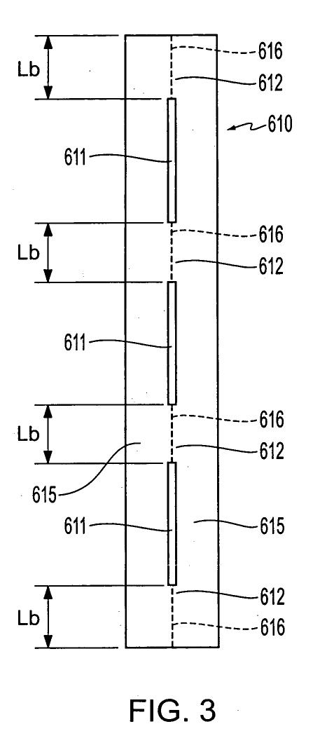

A method of connecting motor lead wires 51 according to the embodiment of the invention will be described with reference to FIGS. 1 to 13. The embodiment includes a method of connecting motor lead wires, in which plural motor lead wires 51 formed with a insulating coating are connected to one another while electric conduction is ensured. The method adopts, as shown in FIGS. 3 through 5, a connection terminal 61 comprising slots 611 formed to pass therethrough parallelly arranged motor lead wires 51, a pair of side plate portions 615 formed on both sides of the slots 611 in a longitudinal direction, and bridge portions 612 connecting the pair of side plate portions 615 together.

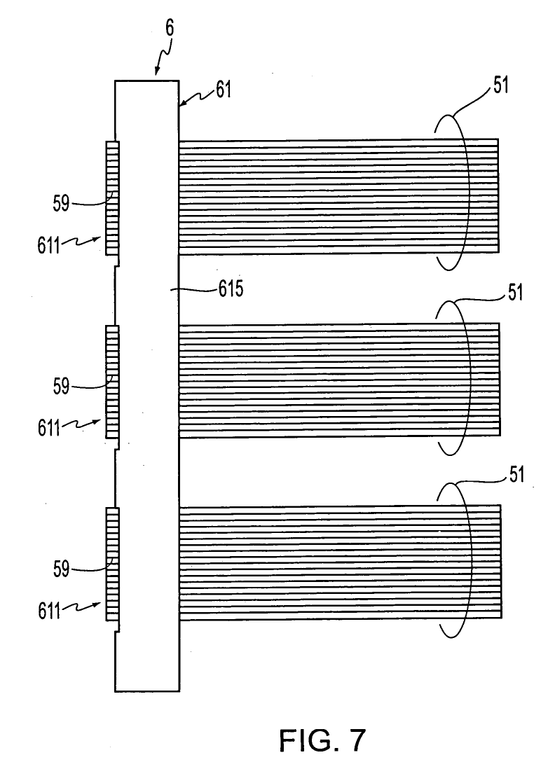

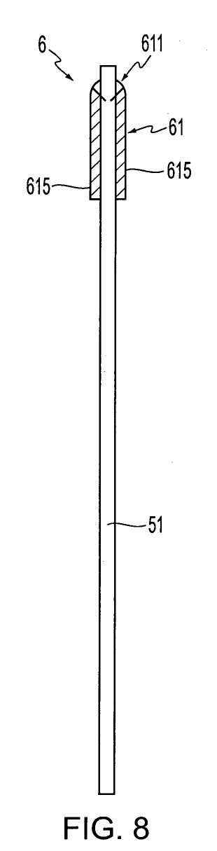

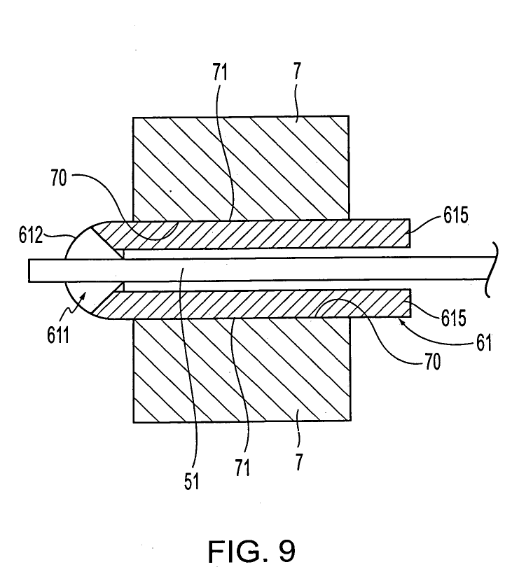

After the passing-through process (FIGS. 7 and 8), in which the motor lead wires 51 are passed through the slots 611 of the connection terminal 61 in a parallelly arranged state, the fusing process (FIG. 9) is executed, in which the side plate portions 615, opposed to each other with the motor lead wires 51 therebetween, are interposed by a pair of electrodes 7 to be pressurized, a predetermined current is conducted from one of the side plate portions 615 to the other of the side plate portions 615 to generate heat to electrically connect the connection terminal 61 and the motor lead wires 51 to each other.

The process will be described below in detail.

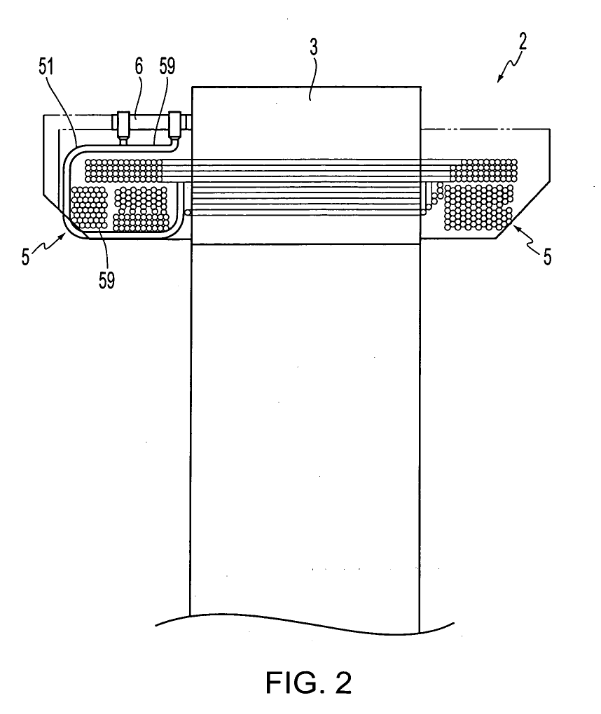

A motor (illustration is omitted), to which the method of connecting motor lead wires according to the embodiment is applied, comprises a three-phase motor. A stator 2 used in the motor comprises, as shown in FIGS. 1 and 2, a ring-shaped stator core 3, coil aggregates 5 (FIG. 2) composed of three phases, that is, a U-phase, V-phase, and W-phase, and a bus bar 6 as a neutral terminal for connection of the motor lead wires 51 (referred to below as neutral wires 51) serving as neutral wires for the respective motor phases.

The coil aggregates 5 are aggregates of coils of the three phases, that is, the U-phase, V-phase, and W-phase. The coils are inserted and arranged in a plurality of slots (illustration is omitted) formed radially on an inner peripheral side of the stator core 3 as shown in FIG. 2. Two of the coil aggregates 5 are inserted and arranged in the stator core 3.

Here, ends 59 of the neutral wires 51, which constitute the respective phases of the respective coil aggregates 5 are drawn out on the inner peripheral side of the stator core 3 as shown in FIG. 2 and circumscribed along outer peripheries of the coil aggregates 5 to be drawn out on an outer peripheral side. The respective ends 59 are parallelly arranged along the outer peripheries of the coil aggregates 5 to be connected to the bus bar 6.

The bus bar 6 is arranged on an outer peripheral surface of the stator core 3 as shown in FIG. 2. Electrically connected to the bus bar 6, in the manner described above, are the ends 59 of the neutral wires 51 drawn out from the coil aggregates 5 of the respective motor phases.

In addition, with the embodiment, two bus bars 6, corresponding to two coil aggregates 5 are arranged on the stator 2. Each bus bar 6 comprises, as shown in FIGS. 7 and 8, the connection terminal 61, which is made of a conductive material and to which the neutral wires 51 are electrically connected.

The connection terminal 61 comprises, as shown in FIG. 3, a part fabricated from a member 610 in the form of lengthy rectangular flat plate. Formed along a central axis, in the longitudinal direction, are the slots 611, of which the longitudinal direction is aligned with the central axis. The member 610 with slots 611 may be formed by stamping with a press machine (not shown).

Formed in three locations on the connection terminal 61 according to the embodiment are the slots 611, which are disposed at substantially equal spacings Lb corresponding to the respective motor phases of the three-phase motor. The bridge portions 612 are arranged between adjacent slots 611.

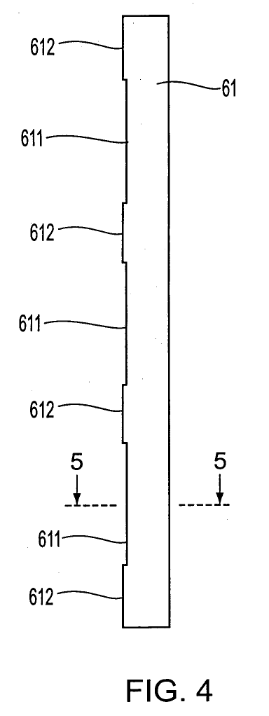

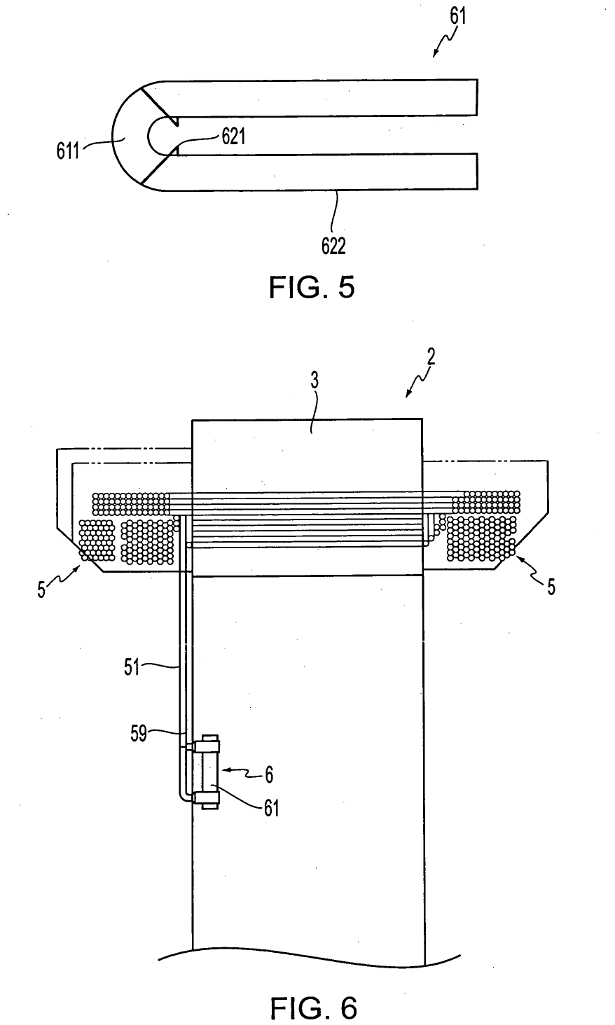

As shown in FIGS. 4 and 5, the connection terminal 61 is fabricated by bending about a bending line 616 (FIG. 3), which is substantially aligned with the longitudinal direction of the slots 611, until the side plate portions 615 on both sides of the bending line 616 face each other.

At this time, burrs 621, produced when the slots 611 are formed by the punching work, are preferably directed toward an inside of the bending. The reason for this is that the mechanical strength of the connection can be enhanced by engaging such burrs 621 with the neutral wires 51, which pass through the slots 611.

Also, the connection terminal 61 is curvedly formed to be substantially arcuate so that a mount surface 622 (FIG. 5) of the connection terminal 61 extends along the outer peripheral surface of the stator core 3.

The bus bar 6 is formed by inserting the ends 59 of the neutral wires 51 of the respective motor phases into the respective slots 611 of the connection terminal 61 as shown in FIGS. 7 and 8 and performing electric connection by a fusing treatment to be described. The ends 59 of the neutral wires 51 of the respective motor phases are parallelly arranged in the respective slots 611 of the connection terminal 61.

The three-phase motor assembled in the above-mentioned manner can be fabricated by the following procedure, which includes the method of connecting motor lead wires, described above. In order to fabricate the stator 2, three phase coils, constituting the coil aggregates 5, are first inserted and arranged in slots (not shown) of the stator core 3 as shown in FIG. 6. At this time, the ends 59 of the neutral wires 51 extending from the respective coil aggregates 5 are directed toward a center of the inner peripheral side of the stator core 3 as shown in the figure. Subsequently, the bus bar 6, as a neutral terminal, is formed as shown in FIG. 6 by executing the method of connecting motor lead wires, illustrated above, and performing electric connection of the respective neutral wires 51 through the connection terminal 61.

Here, the passing-through process, in which the neutral wires 51 of U-phase, V-phase, and W-phase, respectively, are passed through the respective slots 611 of the connection terminal 61. In the passing-through process, the connection terminal 61 is first arranged inside the stator core 3 as shown in FIG. 6.

The ends 59 of the neutral wires 51, arranged to be directed toward the inner peripheral side of the stator core 3 in the above-mentioned manner, are passed through the respective slots 611 of the connection terminal 61 as shown in FIGS. 7 and 8. At this time, the insulating coating of the ends 59 is left as it is. Subsequently, the connection terminal 61, in a state in which the side plate portions 615 face each other with the neutral wires 51 therebetween as shown in FIG. 9, is subjected to the fusing process, in which a fusing treatment is executed.

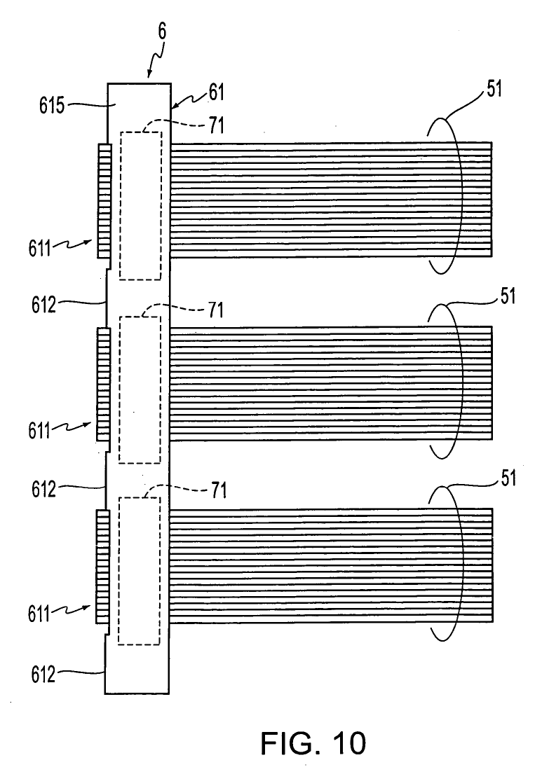

In the fusing process, electrode surfaces 70 of the pair of electrodes 7 arranged to oppose each other are abutted against surfaces of the side plate portions 615 as respective mating electrode surfaces 71 as shown in FIGS. 9 and 10. In the embodiment, tungsten electrodes are used for the electrodes 7. When current is passed therethrough, Joule heat is generated due to internal resistance of the electrodes 7 and the heat is conducted from the electrodes 7 to the connection terminal 61.

Pressure is exerted on the mating electrode surfaces 71 from the respective electrode surfaces 70 to reduce a gap between the opposing side plate portions 615. The action of such pressure adequately brings the electrode surfaces 70 of the respective electrodes 7 and the mating electrode surfaces 71 of the connection terminal 61 into contact with each other, thus suppressing electric resistance therebetween. When the connection terminal 61 is deformed so as to reduce the gap, the mechanical strength of the joint can be enhanced by further firmly interposing the neutral wires 51 in the gap and making the inwardly directed burrs 621 bite into the neutral wires 51.

When a predetermined current is conducted between the electrodes 7 in a state in which the respective electrode surfaces 70 are abutted against the mating electrode surfaces 71 of the connection terminal 61, as shown in FIGS. 9 and 10, current is initially concentratedly conducted to the bridge portions 612 of the connection terminal 61. In particular, with the embodiment, because the insulating coating is formed on the ends 59 of the neutral wires 51 inserted into the connection terminal 61, very little current is passed except via the bridge portions 612. In the embodiment, the total cross sectional area of the bridge portions 612, at the four locations on the connection terminal 61, is 40 square millimeters and the predetermined current is set to be 10 kA.

The bridge portions 612 generate Joule heat according to the quantity of the conducted current. Such Joule heat causes carbonization of the insulating coating of that portion of the neutral wires 51 in contact with the connection terminal 61. At this time, a part of carbide generated from the insulating coating can be discharged outside the connection terminal 61 through the slots 611.

When the predetermined current is passed between the electrodes 7, the current is conducted transversely to and through outer peripheral surfaces of the neutral wires 51 of which the insulating coating has been carbonized. In particular, because a contact area between the respective neutral wires 51 and the side plate portions 615 is not large initially, Joule heat is generated at the contact surface between the neutral wires 51 and the side plate portions 615. The respective neutral wires 51 and the side plate portions 615 are softened by the Joule heat to closely adhere to one another. By electrically connecting the neutral wires 51 and the connection terminal 61 in this manner, the bus bar 6 can be formed to electrically and physically connect them to each other with high reliability.

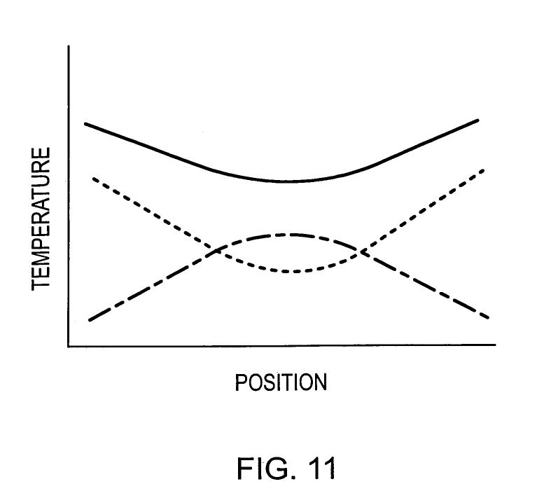

In addition, as a result of the measurement of temperatures in the side plate portions 615 of the connection terminal 61 in the process in which the neutral wires 51 and the connection terminal 61 are connected to each other, a temperature distribution pattern is shown in FIG. 11. The abscissa indicates the relative position of each neutral wire 51 as arranged with the ends of the graph corresponding to the outside neutral wires 51 (neutral wires 51 at the edges of the parallel wires) of each of the motor phases. The ordinate axis indicates temperature. In the figure, a solid line indicates the temperature distribution in the side plate portions 615. The dotted line and the alternate long and short dash line, respectively, in the figure indicate simulation results of temperature distribution in the side plate portions 615 due to Joule heat on the bridge portions 612 and temperature distribution in the side plate portions 615 only due to heat conduction from the electrodes 7 to the side plate portions 615.

As can be seen from FIG. 11, the temperature of the side plate portions 615 is distributed (indicated by the solid line in the figure) relatively evenly in the connection terminal 61 according to the embodiment. There is no extreme deviation in temperature at either a central portion or either end.

The reason why temperature distribution in the side plate portions 615 can be made substantially even resides in the structure of the connection terminal 61 according to the embodiment, and the reason is easily understandable on the basis of the simulation results. That is, temperature distribution (indicated by the dotted line in the figure) in the side plate portions 615 due to Joule heat on the bridge portions 612 and temperature distribution (indicated by the alternate long and short dash line in the figure) in the side plate portions 615 due to heat conduction from the electrodes 7 complement each other.

Joule heat on the bridge portions 612 flows toward the central portion from both edges of the parallelly arranged neutral wires 51. The temperature distribution formed by the Joule heat tends to be high at the edge portions (outside neutral wires 51) close to the bridge portions 612 and low at the central portion of the neutral wires 51 as indicated by the dotted line in FIG. 11.

At the same time, heat conduction from the electrodes 7 to the side plate portions 615 is generated substantially evenly over the whole mating electrode surfaces 71 (FIG. 10) but radiates outward from the outer peripheral portion of the electrodes 7. Therefore, the temperature distribution formed by the Joule heat tends to be low at the edge portions of the parallelly arranged neutral wires 51 and high at the central portion. Because Joule heat on the bridge portions 612 and heat conduction from the electrodes 7 complement each other, the temperature distribution in the side plate portions 615 is substantially evenly distributed as indicated by the solid line in FIG. 11.

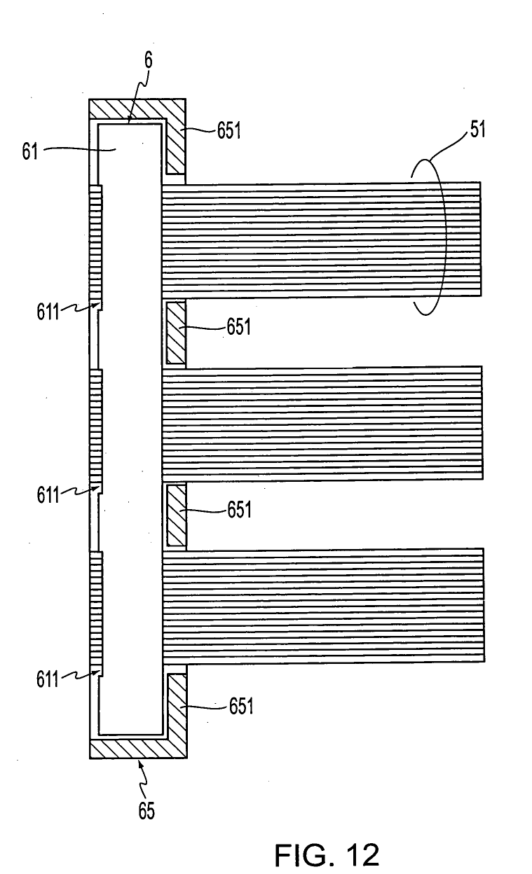

In addition, with the embodiment, the insulating process, in which the bus bar 6 is held in the gap between a folded over insulating paper 65, as shown in FIG. 12, in order to ensure an electric insulating quality of the bus bar 6.

In the embodiment, used as the insulating paper 65 is an insulating paper having a thickness of 0.25 to 0.3 mm and a laminated structure, in which aramid fiber layers having a thermal resistance and a non-conductivity are arranged on both surfaces of a layer of polyethylene naphthalate (PEN), a thermoplastic resin. The insulating paper 65 is structured such that the PEN layer melts due to heating to be eluted from the aramid fiber layers.

In the embodiment, the bus bar 6 is received in a gap in the twofold insulating paper 65 such that the fold line and the slots 611 of the connection terminal 61 are substantially in agreement with each other. And the mutually facing edges 651 of the insulating paper 65 are welded together using an ultrasonic joining machine (not shown). More specifically, the facing edges of the insulating paper 65 are caused to vibrate relative to each other to generate frictional heat to elute the PEN from inside for bonding.

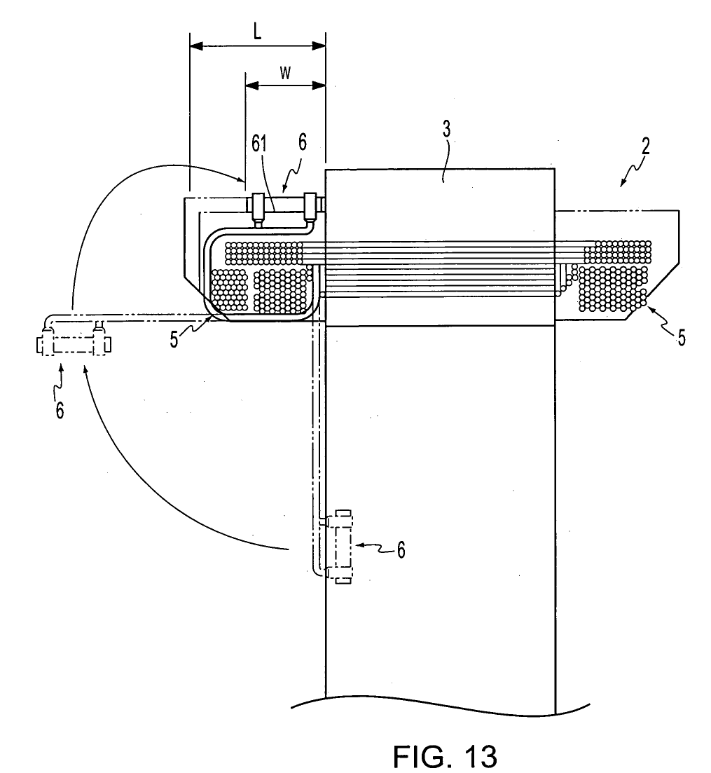

Finally, the bus bar 6, fabricated by means of the method of connecting motor lead wires, is arranged on the outer peripheral surface of the stator core 3 as shown in FIG. 13. Here, the bus bar 6 is positioned in a manner to wind the neutral wires 51 that extend from the coil aggregates 5 to the bus bar 6 around the outer peripheries of the coil aggregates 5. Then, the bus bar 6 positioned up to an outer peripheral side of the stator core 3 is joined to the outer peripheral surface of the stator core 3. A length W of the connection terminal 61 according to the embodiment in an axial direction is made smaller than a magnitude L, by which the coil aggregates 5 arranged on the stator core 3 project in the axial direction. Therefore, the bus bar 6 does not project, relative to the coil aggregates 5, in the axial direction.

As described above, the bus bar 6 electrically connecting the neutral wires 51 and the connection terminal 61 in accordance with the method of connecting motor lead wires, makes it possible to surely connect the respective neutral wires 51 together. That is, according to the method of connecting motor lead wires, the neutral wires 51 can be surely set in the passing-through process in order to pass the parallelly arranged neutral wires 51 through the slots 611.

Because the neutral wires 51 project from the slots 61 1, it is possible to readily inspect by, for example, visual checking, whether a state, in which the respective neutral wires 51 are set, is good or bad. Further, by inspecting whether the respective neutral wires 51 project from the slots 611, it is possible after the fusing process to inspect the state of connection between the connection terminal 61 and the respective neutral wires 51. Also, the bus bar 6 fabricated in the embodiment makes it possible to suppress large-sizing of a motor. That is, because the bus bar 6 can be arranged on the outer peripheral surface of the stator core 3, it is possible to suppress lengthening of a motor in the axial direction.

Further, the neutral wires 51 between the coil aggregates 5 and the bus bar 6 are parallelly arranged along the outer peripheries of the coil aggregates 5. Therefore, the bus bar 6 reduces a concern that the size of the stator core 3 becomes large.

Moreover, according to the method of connecting the motor lead wires, the dispersion in length of the ends 59 of the respective neutral wires 51 drawn from the coil aggregates 5 can be readily accommodated by passing thereof through the slots 611. That is, by adjusting lengths of the neutral wires 51 projecting outside through the slots 611, the lengths of the respective neutral wires 51 between the connection terminal 61 and the coil aggregates 5 can be made equal to one another. That is, after the neutral wires 51 are connected to the connection terminal 61 to form the bus bar 6, the tip ends 59 of the neutral wires 51 projecting outside through the slots 611 can be cut to an even length.

In addition, in the case where lengths of the ends 59 of the neutral wires 51 drawn from the coil aggregates 5 are substantially even, the respective neutral wires 51 and the connection terminal 61 can be accurately connected to each other by substantially equalizing lengths of the neutral wires 51 projecting through the slots 611 to one another.

The respective neutral wires 51 can be accurately arranged on the connection terminal 61 by, for example, setting a holder plate, or the like, in a direction of projection outwardly of the slots 611 and causing the tip ends of the respective neutral wires 51 passed through the slots 611 to abut against the holder plate.

As previously stated, according to the method of connecting motor lead wires of this embodiment, at least a part of the carbide from the insulating coating, generated in the fusing process can be discharged outside through the slots 611. Thus, the bus bar 6 in the embodiment can suppress the presence of carbide on the contact surfaces between the connection terminal 61 and the neutral wires 51. Therefore, a large contact area can be ensured between the connection terminal 61 and the neutral wires 51.

Further, according to the embodiment, while the passing-through process is executed for the connection terminal 61 bent so that the pair of side plate portions 615 face each other, the order of steps can be modified. In this case, the passing-through process is executed for a connection terminal in the form of a flat plate, after which the connection terminal may be bent so that the pair of side plate portions 615 face each other, or the passing-through process is executed for a partially bent connection terminal, after which the connection terminal can be further bent to cause the pair of side plate portions 615 to face each other.

Also, extending electrode surfaces 70 (only one surface is shown in FIG. 9 and all three surfaces of one electrode 7 are shown by dotted lines in FIG. 10) are formed in three locations on the electrodes 7 to correspond to the mating electrode surfaces 71 in three locations on the connection terminal 61 as shown in FIG. 10. According to the embodiment, the electrodes 7 are used to simultaneously execute the fusing treatment for the neutral wires 51 of the respective motor phases.

Instead of this, the electrode surfaces 70 of the electrodes 7 may be formed in a manner to abut against the whole surfaces of the side plate portions 615 so that the whole surfaces of the side plate portions 615 of the connection terminal 61 serve as mating electrode surfaces.

Also, the electrode surfaces 70 of the electrodes 7 may be formed in a manner to abut only against the mating electrode surface 71 (FIG. 10) in one location on the connection terminal 61. In this case, the fusing treatment can be carried out with a relatively small-sized electrode 7.

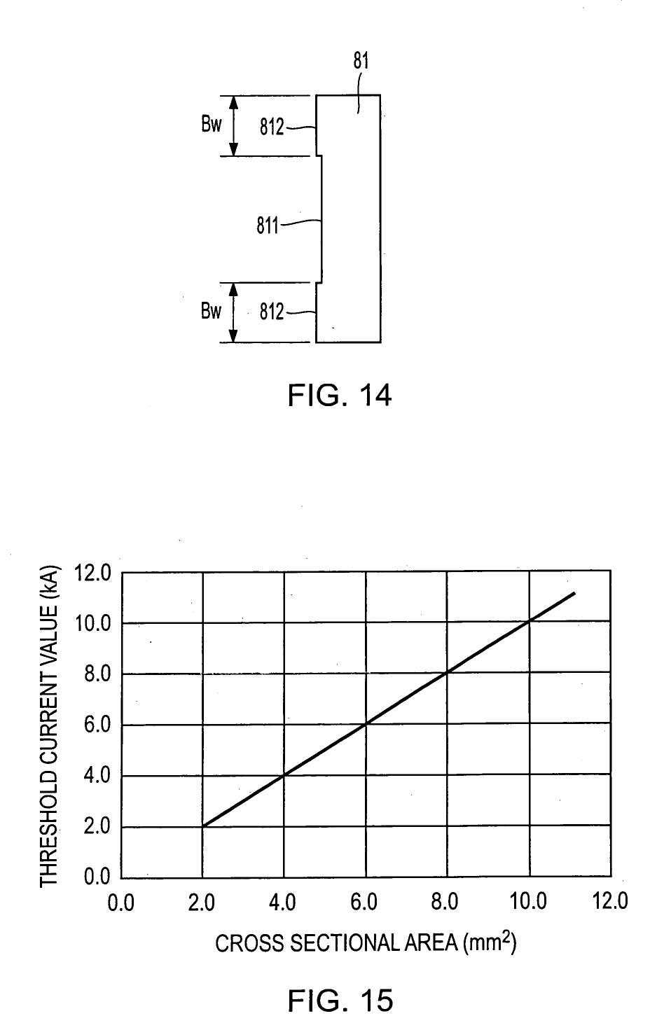

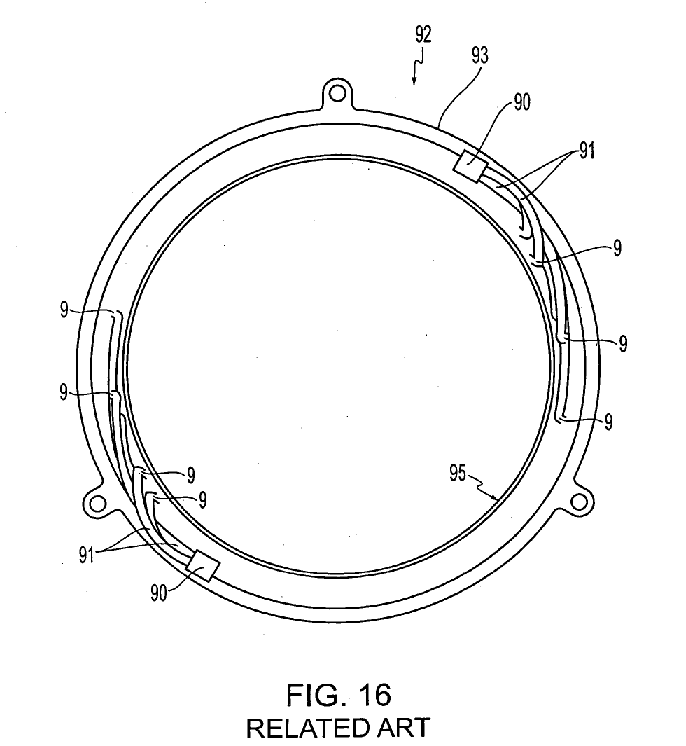

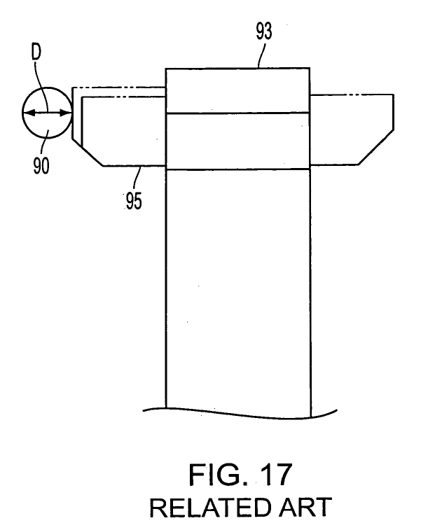

The relationship between a cross sectional area of the bridge portions and an appropriate range of the predetermined current is examined based on the fusing treatment in the embodiment as just discussed. Contents of a method that establishes parameters of the connection terminal are described with reference to FIGS. 14 and 15.

In the methodology, a test piece 81, having substantially the same cross sectional structure as that of the connection terminal 61 described above, has bridge portions 812 on each end thereof and a slot 811 between the bridge portions 812, as shown in FIG. 14. Experiments were conducted on several kinds of test pieces 81 in which the width Bw of the bridge portions 812 was changed.

The respective test pieces 81 were fabricated by bending a flat sheet having a thickness of 1 mm and formed with a slot having a width of 20 mm. In the experiments, the bridge portions 812 at each end were changed in width Bw so that a total cross sectional area of the bridge portions 812 at both ends was changed in a range of not less than 2.0 square millimeters.

Then the same fusing treatment as that described for the embodiment was carried out with parallelly arranged motor lead wires passed through the slots 811 of the respective test pieces 81. The current conducted between the electrodes, for fusing joining, was changed and threshold current values, at which the bridge portions 812 were broken, were examined with respect to the respective test pieces 81. As a result, a proportional connection between the total cross sectional area of the bridge portions 812 at each end and the threshold current values was found as shown in FIG. 15. That is, the larger the total cross sectional area of the bridge portions 812, the larger the threshold current values, and the smaller the total cross sectional area of the bridge portions 812, the smaller the threshold current values.

When the fusing treatment is carried out, it is essential to appropriately generate Joule heat in that range in which the bridge portions 812 are not broken. Empirically, the fusing treatment can be carried out efficiently by conduction of current of not less than 50% but not more than 90% of threshold current values shown in FIG. 15. In the case of less than 50%, there is a fear that Joule heat generated on the bridge portions 812 is not sufficient and, in the case of more than 90%, the bridge portions 812 are in some cases damaged due to dimensional dispersion of those members, which constitute the bridge portions 812.

What is claimed is:

1. A method of connecting a plurality of motor lead wires formed with an insulating coating while ensuring electric conduction among them, the method comprising
using a connection terminal, which has holes formed so as to permit the motor lead wires arranged in parallel to extend therethrough, a pair of side plate portions formed on both sides of the holes, and bridge portions connecting the pair of side plate portions to one another, to execute a passing-through process, in which the motor lead wires arranged in parallel are passed through the holes of the connection terminal;
executing a fusing process, in which the side plate portions facing each other with the motor lead wires interposed therebetween are sandwiched by opposed electrodes and pressed; and
conducting a predetermined current between the opposed electrodes from one of the side plate portions to the other of the side plate portions to generate heat to electrically connect the connection terminal and the motor lead wires to each other.

2. The method according to claim 1, wherein the holes are slots extending in a longitudinal direction of the connection terminal and the pair of side plate portions are formed on both sides of the slots in the longitudinal direction.

3. The method according to claim 1, wherein the predetermined current is changed in magnitude according to the cross sectional areas of the bridge portions in the fusing process.

4. The method according to claim 1, wherein the insulating coating formed on outer peripheries of the motor lead wires is carbonized in the fusing process.

5. The method according to claim 1, wherein the passing-through process is executed for the connection terminal, in which the pair of side plate portions are formed to face each other prior to executing the passing-through process.

6. The method according to claim 1, wherein after the passing-through process is executed and before the fusing process is executed, the connection terminal is bent in a manner to have the pair of side plate portions facing each other.

7. The method according to claim 1, wherein after the fusing process, tip ends of the motor lead wires projecting from the slots are cut.

8. The method according to claim 1, wherein after the fusing process, an insulating process is executed, in which the connection terminal and the respective motor lead wires disposed in the vicinity thereof are covered by an insulating paper that is electrically insulative.

9. A connection structure of motor lead wires, in which a plurality of motor lead wires are connected together while electric conduction among them is ensured, the connection structure comprising a connection terminal having slots formed so as to permit the motor lead wires arranged in parallel to extend therethrough, a pair of side plate portions interposing the motor lead wires passing through the slots to face each other, and bridge portions connecting the pair of side plate portions to each other, wherein the motor lead wires arranged in parallel are passed through the slots, and interposed between the pair of side plate portions to be electrically connected to the connection terminal.

10. The connection structure according to claim 9, wherein edges of the connection terminal adjacent to the slots are formed with projections to project toward a gap between the pair of side plate portions, and the projections engage with the motor lead wires.

11. The connection structure according to claim 9, wherein the connection terminal comprises a plurality of the slots, and the plurality of motor lead wires arranged in parallel are passed through the respective slots.

12. The connection structure according to claim 9, wherein the connection terminal and the respective motor lead wires disposed in the vicinity thereof are covered by an insulating paper that is electrically insulative.

13. A motor comprising a ring-shaped stator core, on which coils constituting respective motor phases are arranged, and a neutral terminal ensuring mutual electric conduction of a plurality of motor lead wires, which are drawn from the respective motor phases to serve as neutral wires, to connect them, and wherein the neutral terminal is constructed to connect the motor lead wires according to claim 9.

14. The motor according to claim 13, wherein a connection terminal on the neutral terminal is arranged on an outer peripheral surface of the stator core and the connection terminal assumes a substantially arcuate shape along the outer peripheral surface of the stator core.

15. The motor according to claim 14, wherein the connection terminal on the neutral terminal comprises separate slots for each motor phase and the neutral wires for the respective motor phases are passed through the respective slots.

16. The motor according to claim 15, wherein the neutral terminal defines a neutral point in a three-phase motor.

17. The motor according to claim 13, wherein the connection terminal on the neutral terminal comprises separate slots for each motor phase and the neutral wires for the respective motor phases are passed through the respective slots.

18. The motor according to claim 17, wherein the neutral terminal defines a neutral point in a three-phase motor.
